(19) United States
(12) Patent Application Publication
(10) Pub. No.: US 2011/0101892 A1
(43) Pub. Date: May 5, 2011

(54) Accelerator for Accelerating Charged Particles

(76) Inventor: Oliver Heid, Erlangen (DE)

(21) Appl. No.: 13/002,163

(22) PCT Filed: Jun. 23, 2009
(86) PCT No.: PCT/EP09/57774

§ 371 Date: Dec. 30, 2010

(30) Foreign Application Priority Data
Jul. 4, 2008 (DE) 10 2008 031 757.8

(51) Int. Cl. H05H 9/00

(52) U.S. Cl. 315/505

(57) ABSTRACT

An accelerator for accelerating charged particles has a plurality of delay lines (13, 15) that are directed at a beam trajectory (35) and that are disposed in succession in the direction of the beam trajectory (35), wherein at least some of the delay lines (13, 15) are rotated with respect to one another relative to the beam trajectory (35).

### CROSS-REFERENCE TO RELATED APPLICATIONS

This application is a U.S. National Stage Application of International application Ser. No. PCT/EP2009/057774 filed Jun. 23, 2009, which designates the United States of America, and claims priority to DE Application No. 10 2008 031 757.8 filed Jul. 4, 2008. The contents of which are hereby incorporated by reference in their entirety.

### TECHNICAL FIELD

The invention relates to an accelerator for accelerating charged particles and to a method for operating such an accelerator. Such an accelerator can be used in fields such as medical technology, especially in radiotherapy, where it is necessary, in order to generate a treatment beam, to accelerate charged particles such as electrons, protons or other charged ions for example. The charged particles can either be used to generate x-ray Bremsstrahlung (braking radiation) or directly for irradiating a target object.

### BACKGROUND

Dielectric wall accelerators (also abbreviated to DWA) are devices known for this purpose. Such accelerators are usually non-ferrous induction particle accelerators usually comprising a package with a plurality of delay lines and the method of operation of which is based on a different delay time of electromagnetic waves in the delay lines. The basic principle of the propagation of an electromagnetic signal in the delay line is disclosed for example in U.S. Pat. No. 2,465,840 by A. D. Blumlein.

In an accelerator current impulses are introduced into the plurality of delay lines or the delay lines. The geometrical arrangement of delay lines and the electromagnetic waves generated by the current impulses create a magnetic field that changes over time or a change in the magnetic flux, which—depending on the geometrical arrangement of the delay lines—generates an accelerating electrical potential at one location, e.g. within a beam tube. The electrical potential is used to accelerate charged particles.

A particle accelerator at this type is known for example from U.S. Pat. No. 5,757,146. A stack of disk-shaped capacitor pairs is used here as a package of delay lines. A capacitor pair in such cases consists of two disc-shaped plate capacitors. The height of the plate capacitors and of the dielectrics between the capacitor plates is selected so that an electromagnetic impulse wave in one capacitor of the capacitor pair propagates considerably more quickly than in the other capacitor. Such a capacitor pair is also referred to, in compliance with the delay line disclosed by A. D. Blumlein, as an asymmetric Blumlein or Blumlein module.

The stack of disk-shaped capacitor pairs or Blumlein modules is arranged in such cases around a central tube. Each second capacitor plate is at a positive potential in relation to the other capacitor plates. In the static case the capacitors alternately generate opposed electrical fields in each case which compensate for each other within the stack, i.e. along the central tube. If the capacitor plates are now short-circuited at the outer circumference an electromagnetic impulse wave propagates radially inwards between each capacitor plate pair. The faster propagation speed of the impulse wave directed into the center in each second capacitor means that the impulse wave front in each second capacitor reaches the central tube at a time at which the impulse wave front in the other capacitors is still on its way inwards and has not yet reached the central tube. This produces a constellation of electromagnetic fields, which for a certain time creates an electrical potential in the center of the stack along the tube. This potential generated by a capacitor pair amounts in the ideal case to double the charge voltage of the capacitor plates and exists until such time as the slower impulse wave has also reached the central tube. This period of time can be used to accelerate charged particles along the tube. At the output of the delay line—in this case at the inner tube—the impulse waves will be reflected. This too occurs, as a result of the different delay times, at different points in time.

The paper by Caporaso, G J et al. “High Gradient Induction Accelerator”, Particle Accelerator Conference, Jun. 25-29, 2007, mentions among other things the option of varying the permittivity number for a disk-shaped embodiment of the period/the delay line as a function of the radius in order to keep the field wave impedance constant with a delay line constructed in the form of a disk.

In the book by Humphries, S, “Principles of Charged Particle Acceleration”, ISBN 0-471-87878-2, it is disclosed on page 317 ff. that the gap between the electrode plates increases with the radius so that a homogenous dielectric can be used and an impedance remaining the same radially can still be achieved.

WO 2008/051358 A1 discloses various forms of embodiment of delay line, including Blumlein modules which run in the form of strips centrally inwards onto a beam tube. The strip-type Blumlein modules can in such cases also assume a curved shape.

The article by Caporaso, G J, “High Gradient Induction Cell”, Proceedings of the Workshop on Accelerator Driven High Energy Density Physics, Oct. 26-29, 2004, Lawrence Berkeley National Laboratory, and the article by Nelson, S D, Poole, B R, “Electromagnetic Simulations of Dielectric Wall Accelerator Structures for Electron Beam Acceleration”, Particle Accelerator Conference, 2005, PAC 2005, Proceedings of the 16-20 May 2005, 2550-2552 likewise describe a structure of the Blumlein modules with flat, linear, strip-shaped delay lines.

### SUMMARY

According to various embodiments, an accelerator can be provided which makes effective acceleration of charged particles possible with simple manufacturing.

According to an embodiment, an accelerator for accelerating charged particles may comprise a number of delay lines which are directed at a beam trajectory and which are disposed in succession in the direction of the beam trajectory, wherein at least some of the delay lines are rotated with respect to one another relative to the beam trajectory.

According to a further embodiment, the delay lines can be disposed in Blumlein modules, with a Blumlein module comprising a pair with a fast delay line and a slow delay line and with at least some of the Blumlein modules being rotated in respect of one another in relation to the beam trajectory. According to a further embodiment, the delay lines can be embodied in the form of strips. According to a further embodiment, with some of the delay lines, the delay lines can be interlaced with one another. According to a further embodiment, with some of the delay lines, the delay lines can be interlaced with one another such that the interlaced delay lines assume a shape which has a height increasing radially outwards. According to a further embodiment, the shape can be able to be disposed within a rotationally symmetrical enveloping surface around the beam trajectory which has a height decreasing radially outwards. According to a further embodiment, the enveloping surface can be able to be created by rotation of a hyperbola around the beam trajectory. According to a further embodiment, the delay linescan be interconnected via a ring electrode.

### BRIEF DESCRIPTION OF THE DRAWINGS

Embodiments in accordance with the features of the dependent claims are explained in greater detail with reference to the following drawing, but without being restricted to said drawing. The figures show:

FIG. 1 a longitudinal section through a Blumlein module with a dual-conductor structure which is directed in a straight line radially inwards at a beam trajectory,

FIG. 2 a plan view of eight Blumlein modules embodied in the form of strips, rotated in relation to another, with each Blumlein module comprising a double layer of individual conductors,

FIG. 3 a perspective view of eight Blumlein modules embodied in the form of strips, interlaced with one another,

FIG. 4 a more detailed diagram of one of the Blumlein modules from FIG. 3,

FIG. 5 a diagram of hyperbolic enveloping curves along the beam tube.

### DETAILED DESCRIPTION

The accelerator according to various embodiments for accelerating charged particles comprises a number of delay lines that are normally directed at a beam trajectory and that are disposed in succession in the direction of the beam trajectory. At least a few of the delay lines are rotated with respect to one another relative to the beam trajectory. The axis of rotation in this case is the beam trajectory.

This means that—viewed in the direction of the beam trajectory—the projections of the delay lines do not lie directly above one another but are rotated with respect to one another. The projections do not overlap completely and only partly intersect with one another. The delay lines are directed at a beam trajectory, which means that an electromagnetic wave coupled into the delay line is likewise directed at the beam trajectory or can return after reflection. As regards the direction of movement of the beam trajectory the delay lines are arranged one after the other. For example the delay lines can be arranged stacked in succession along the beam trajectory.

According to various embodiments, with a delay line with a disk-type structure, the spatial propagation of the electromagnetic fields is actually advantageous. With an annular coupled-in impulse wave running inwards the magnetic flux must namely wind around a centrally arranged beam tube since there is practically no other stray field return flux space. Almost the entire magnetic flux thus generates an electrical potential which can be used for acceleration.

In this case however it has also been recognized that difficulty and effort is involved in achieving a constant field wave impedance, which would be needed for an undistorted propagation of an electromagnetic impulse wave with a disk-type delay line.

If however the two capacitors are filtered for example with a homogenous dielectric and possess a thickness independent of the radius the desired radial impulse wave propagation is impossible: The displacement current density in the impulse front is supplied by the discharge of the dielectric; with small radii there is less impulse front cross-section available, which means that the discharge current cannot be kept constant along the plates.

With a constant geometrical thickness of the disk-type delay line a radially inhomogeneous dielectric would have to be used in order to keep the field wave impedance constant for a delay line constructed in the form of the disk and thereby to make possible the propagation of an impulse wave. This brings with it the problem of establishing a radially variable permittivity number. In addition with a delay line of this type, the energy storage capacity of the dielectric is only completely exploited in the vicinity of the central beam tube. With larger radii the permittivity number and thereby the energy storage capacity must be artificially reduced per volume unit.

Another solution with a radially constant permittivity number, for which the thickness of the delay line increases linearly outwards as a function of the radius, mitigates on the other hand against a compact accelerator design. The stack density achievable with such a configuration is relatively small and is not determined by the acceleration path at the inner edge in the vicinity of the beam trajectory but by the height at the outer edge.

According to various embodiments, although linear strip-type delay lines are easy to manufacture and have a good field wave impedance which largely remains equal even with a homogenous dielectric, such delay lines do not however produce an optimal spatial constellation of electromagnetic fields during operation. During operation introduced waves generate a magnetic flux which exits laterally from the lines and preferably winds directly around the delay line and not around a central beam tube, so that only a part of the generated magnetic flux can be used for the acceleration of charged particles.

For solutions in which a magnetic flux line with magnetic cores is achieved, because of aspects such as the extremely rapid saturation of the magnetic material or the large cross sections required, the solutions cannot be realized or are difficult to realize.

The fact that in the accelerator according to various embodiments the delay lines are rotated in relation to one another means that part of the magnetic flux which would escape laterally from the delay line and would wind itself around the delay line is partly introduced into other delay lines which are arranged rotated in relation to the former. The result is a configuration of the magnetic flux which approaches the advantageous configurations of the magnetic flux with a delay line embodied in the form of a disk and which winds to a large extent around a centrally arranged beam tube. Overall this results in a larger part of the magnetic flux being available for accelerating particles in a beam tube.

Usually the delay lines are arranged in Blumlein modules, with a Blumlein module comprising a pair with a fast delay line and a slow delay line. In these cases at least some of the Blumlein modules are rotated in the accelerator with respect to one another relative to the beam trajectory.

For example such a Blumlein module can be realized using a pair of capacitors, with the capacitor pair comprising a common central electrode and two outer electrodes. There is a dielectric in each case between central electrode and the outer electrodes. This produces a double layer of individual conductors which, through the choice of dielectric and through the geometrical dimensions, can have a delay time for example in the ratio of 1 to 3.

In particular the delay lines can be embodied as strips. In this case the delay lines or the projection of the delay lines in the direction of the beam trajectory essentially has the form of an elongated rectangle which has an essentially constant width of less than eight times the beam tube diameter, especially less than four times the beam tube diameter and most especially less than double the beam tube diameter.

This produces a delay line which is embodied as a type of strip. The elongated strips, as in WO 2008/051358 A1, can assume a curved shape in the strip plane or can narrow towards the beam trajectory. The delay lines embodied as a type of strip have an essentially constant height and an essentially constant width.

In an embodiment, at least with some of the delay lines the delay lines are interlaced with one another. This is possible since the delay lines are rotated with respect to one another so that, as their distance from the beam trajectory increases, they can be arranged staggered. This enables the delay lines to be interlaced with each other, which again offers advantages for the compact design or the interconnection of the delay lines.

In particular some of the delay lines are interlaced with each other such that this causes the interlaced delay lines to assume a shape which has a height decreasing radially outwards. The shape can especially be created such that it is able to be disposed within a rotationally-symmetrical enveloping surface around the beam trajectory, having a height which decreases radially outwards. The enveloping surface can especially be formed by rotation of a hyperbola around the beam trajectory.

These forms of embodiment are based on considerations which look at the problem of an electromagnetic wave moving radially inwards from the standpoint of energy density distribution. A constant energy density distribution w, given by the relationship w=εᵣε₀E² (εᵣ . . . relative permittivity number ε₀ . . . permittivity of the free space, E . . . electrical field strength), means, with a constant permittivity number εᵣ and constant electrical field strength, that the mass of the dielectric per radius element dR should likewise remain constant. This means that an indirect proportional relationship˜1/R is produced between thickness D of the dielectric and the radial spacing R.

The interlacing of the delay lines with each other and the geometrical shape of the interlaced delay lines, which has the form of a height decreasing radially outwards, enables the ideal circumstances listed above to be at least approximately fulfilled.

The interlacing, which becomes greater as the radius increases, also enables the field volume for the magnetic field strength B and the field volume for the electrical field strength E to be of roughly the same order of magnitude, which in the final analysis leads to an improved or even maximized accelerating potential.

The delay lines can also be connected to each other via a common ring electrode which, because of the delay lines rotated in respect to one another, is especially advantageous.

With interlaced delay lines in particular, in which some of the delay lines at the outer end lie in approximately the same plane, this type of ring electrode can take care of their interconnection in a simple manner.

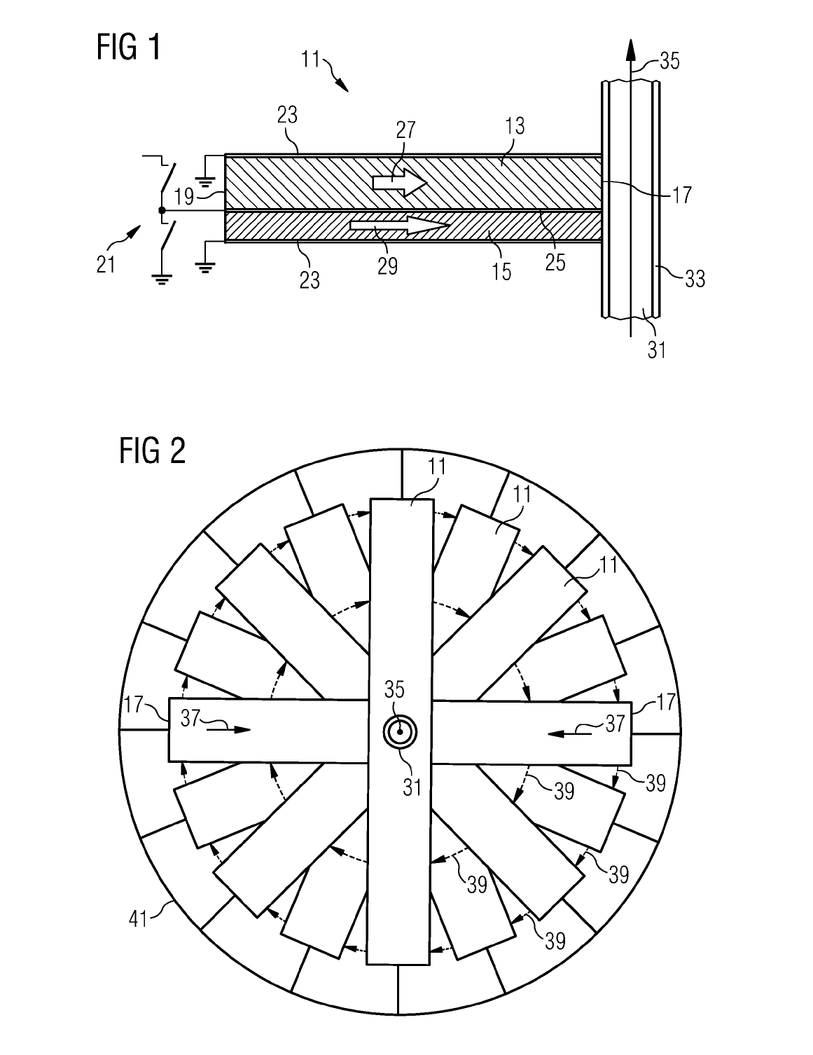

FIG. 1 shows a schematic diagram of the structure of a Blumlein module 11 based on a longitudinal section through a part of the Blumlein module 11. An induction accelerator is constructed from these types of Blumlein modules. A Blumlein module enables an accelerating electrical potential to be generated along a beam trajectory 35. The accelerator normally comprises a plurality of such Blumlein modules 11 which are usually disposed stacked in succession.

In such cases the Blumlein module 11 comprises a fast delay line 15 and a slow delay line 13. The two delay lines 15, 13 are embodied as capacitors, with the capacitor of the fast delay line 15 having a first dielectric with a first permittivity number E1 and with the capacitor of the slow delay line having a second dielectric with a second permittivity number E2. The level of the capacitors and the permittivity numbers of the dielectrics is selected in such cases such that an electromagnetic wave propagates significantly faster in the fast delay line 15 than in the slow delay line 13, shown symbolically by the thin arrows 29 or by the thick arrows 27 respectively. An especially favorable level relationship is produced by a ratio of 1:\sqrt{3}, for a ratio of the permittivity numbers E1:E2 of 1:9. The impedance can be maximized with these parameters, which minimizes the currents necessary for switching. The delay times of electromagnetic waves in the two delay lines 13, 15 behave in this case with a relationship of 1:3.

The two outer capacitor plates 23, i.e. the outer electrodes, are grounded, whereas the central capacitor plates 25 or the central electrode can be set to a specific potential depending on the circuit. For this purpose a circuit arrangement 21 is located on the input side of the delay lines 13, 15 with which the central capacitor plate can be set to a specific potential. With a short-circuit of the central electrode and the outer electrodes this generates an electromagnetic impulse wave which propagates from the input side 19 radially inwards to the output side 17. On the output side 17 there is a beam tube 31 insulated from the Blumlein module 11 by a vacuum insulator 33 in which—caused by the different delay times of the electromagnetic waves—an electrical potential is generated for a certain period, which can be exploited for the acceleration of charged particles along a beam trajectory 35.

FIG. 2 shows a plan view of eight Blumlein modules 11 embodied in the form of strips which are disposed stacked in succession along a beam tube 31. The beam tube 31 runs in this case through the center of each of the Blumlein modules 11 embodied in the form of a strip. The Blumlein modules 11 in this case are rotated in relation to one another as regards the beam trajectory 35 as an axis of rotation which runs at right angles to the plane of the drawing. The projections of the Blumlein modules 11 in the direction of the beam trajectory 35 are not overlapping because of their rotation in respect to one another.

Two arrows 37 directed radially inwards illustrate for one of the Blumlein modules 11 the direction in which the electromagnetic waves are running, which can be coupled in on the input side 17 of the Blumlein modules 11. The electromagnetic waves are directed at to the beam tube 31. This produces a configuration of electromagnetic fields which at least in part generates a magnetic flux which runs around the beam tube and which changes over time. This magnetic flux changing over time generates inside the beam tube 31 an accelerating electrical potential along the beam trajectory 35.

The magnetic flux which is generated by an electromagnetic wave propagating in a Blumlein module 11 exits in some cases laterally from the individual Blumlein modules, symbolized by the dotted arrows 39. This laterally exiting magnetic flux is now partly directed by the Blumlein modules 11 rotated in respect to one another so that it enters into other Blumlein modules 11 and is wound by this process around the beam tube 31.

Without the rotation of the Blumlein modules 11 a part of this magnetic flux which is now routed around the beam tube 31 would be routed around the longitudinal direction of the Blumlein modules embodied in the form of strips, i.e. around the propagation direction of the electromagnetic wave. This part would thus not contribute to the accelerating electrical potential. Through the rotation of the Blumlein modules 11 in respect to one another the generated accelerating electrical potential is thus increased since the magnetic flux arising is routed increasingly around the beam tube 31.

For connecting the Blumlein modules 11 a ring electrode 41 can be provided which makes it possible to couple electromagnetic impulse waves into the Blumlein modules 11.

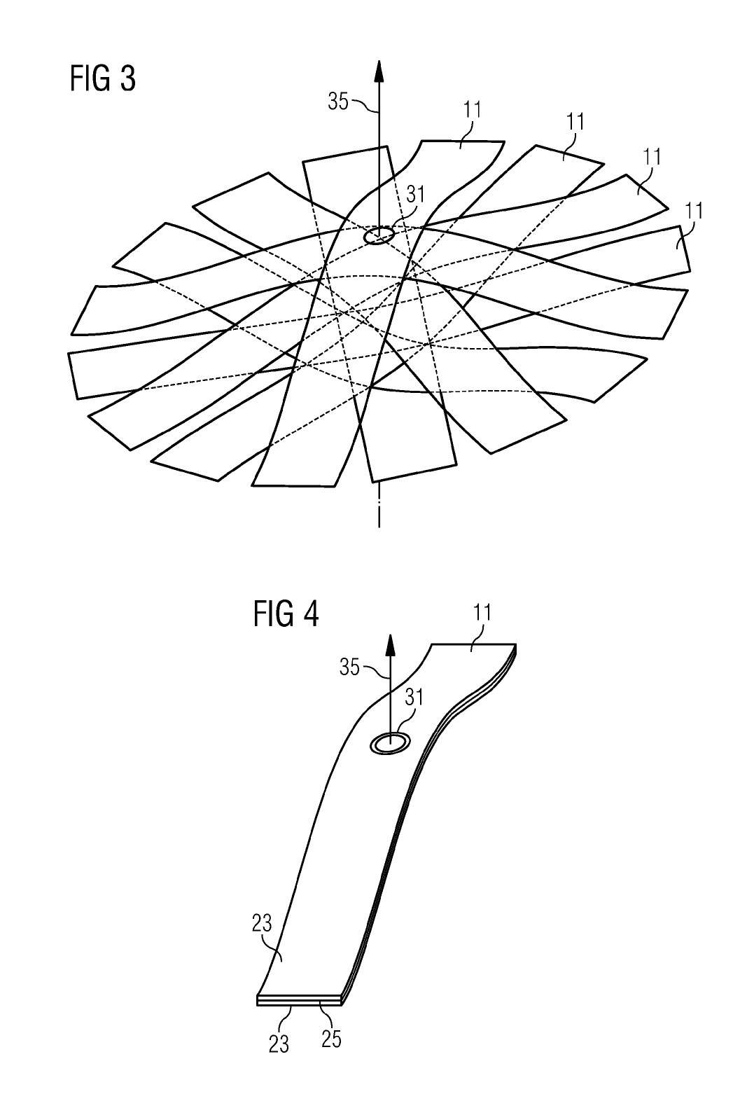

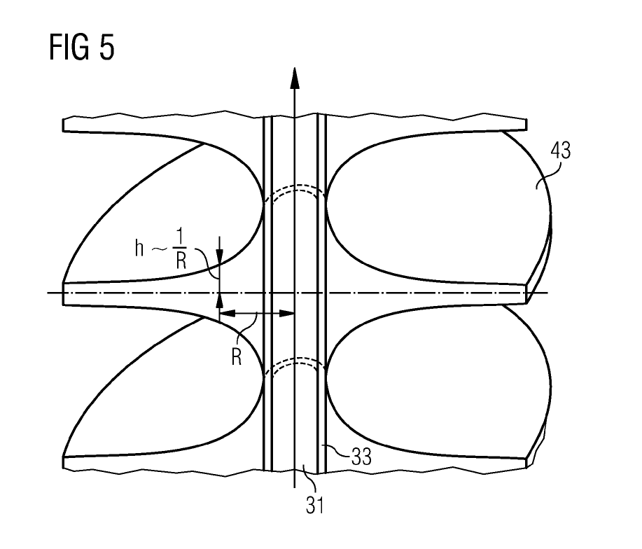

FIG. 3 shows a perspective view of the Blumlein modules 11 embodied in the form of strips. In this perspective view it can be clearly seen that the Blumlein modules 11 are interlaced relative to one another. For the interlacing of the delay lines a delay line embodied in the form of a strip thus no longer runs in one plane but is bent. FIG. 4 shows an enlarged diagram of the topmost delay line of the stack in which the layer-type structure can be seen with a central electrode 25 and two outer electrodes 23.

The fact that the circumference grows with increasing radius means that more space is available as the radius increases to dispose Blumlein modules 11 alongside one another while the Blumlein modules 11 around the beam tube 31 are disposed in succession along the beam tube 31, i.e. as a type of stack.

The interlaced delay lines disposed alongside one another are especially easy to connect via a ring electrode disposed in one plane.

FIG. 5 shows enveloping surfaces 43 arranged around the beam tube 31 which, with an increasing radius R, have a hyperbolically decreasing height h. For enhanced clarity the envelope surfaces 43 and the beam tube 31 are shown in cross-section. The strip-type delay lines interlaced into each other shown in FIG. 3 can be arranged within an enveloping surface 43 such that they are within the enveloping surface 43. The advantages able to be achieved by this are described above. A group with strip-type delay lines interlaced into each other shown in FIG. 3 can be disposed repeatedly along the beam tube so that the generation of a large accelerating potential is possible.

What is claimed is:

1. An accelerator for accelerating charged particles comprising:
a number of delay lines which are directed at a beam trajectory and which are disposed in succession in the direction of the beam trajectory,
wherein
at least some of the delay lines are rotated with respect to one another relative to the beam trajectory.

2. The accelerator according to claim 1, wherein
the delay lines are disposed in Blumlein modules, with a Blumlein module comprising a pair with a fast delay line and a slow delay line and with at least some of the Blumlein modules being rotated in respect of one another in relation to the beam trajectory.

3. The accelerator according to claim 1, wherein
the delay lines are embodied in the form of strips.

4. The accelerator according to claim 1, wherein
with some of the delay lines, the delay lines are interlaced with one another.

5. The accelerator according to claim 4, wherein,
with some of the delay lines, the delay lines are interlaced with one another such that the interlaced delay lines assume a shape which has a height increasing radially outwards.

6. The accelerator according to claim 5, wherein
the shape is able to be disposed within a rotationally symmetrical enveloping surface around the beam trajectory which has a height decreasing radially outwards.

7. The accelerator according to claim 6, wherein
the enveloping surface is able to be created by rotation of a hyperbola around the beam trajectory.

8. The accelerator according to claim 1, wherein
the delay lines are interconnected via a ring electrode.

9. A method for providing an accelerator for accelerating charged particles, comprising:
directing number of delay lines which at a beam trajectory and disposing them in succession in the direction of the beam trajectory, and
rotating at least some of the delay lines with respect to one another relative to the beam trajectory.

10. The method according to claim 9, comprising:
disposing the delay lines in Blumlein modules, with a Blumlein module comprising a pair with a fast delay line and a slow delay line and with at least some of the Blumlein modules being rotated in respect of one another in relation to the beam trajectory.

11. The method according to claim 9, comprising
embodying the delay lines in the form of strips.

12. The method according to claim 9, wherein,
with some of the delay lines, the delay lines are interlaced with one another.

13. The method according to claim 12, wherein,
with some of the delay lines, the delay lines are interlaced with one another such that the interlaced delay lines assume a shape which has a height increasing radially outwards.

14. The method according to claim 13, wherein
the shape is able to be disposed within a rotationally symmetrical enveloping surface around the beam trajectory which has a height decreasing radially outwards.

15. The method according to claim 14, wherein
the enveloping surface is able to be created by rotation of a hyperbola around the beam trajectory.

16. The method according to claim 9,
further comprising: interconnecting the delay lines via a ring electrode.
